(19) United States
(12) Patent Application Publication
(10) Pub. No.: US 2002/0028680 A1
(43) Pub. Date: Mar. 7, 2002

(54) System, method and computer program product for wireless data transmission over conventional television frequency bands

(75) Inventors: Brett Jenkins, West Springfield, MA (US); Jerry D. Chase, LePecq (FR); Wayne R. Hoffman, Longmeadow, MA (US); Paulo Correa, Kingston, PA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: OPEN PIT NETWORKS, INC, Southwick, MA

(21) Appl. No.: 09/900,143

(22) Filed: Jul. 9, 2001

Related U.S. Application Data
(60) Provisional application No. 60/216,769, filed on Jul. 7, 2000.

(51) Int. Cl. H04Q 7/20

(52) U.S. Cl. 455/454; 455/450; 455/464

(57) ABSTRACT

A communications system, method and computer program product, including, transmitting in a terrestrial analog broadcast channel digital information common to users within a broadcast coverage area and digital information unique to users within the broadcast coverage area. The system, method and computer program product further include partitioning the terrestrial analog broadcast channel into a common information portion and a unique information portion, digitally modulating, within the common information portion, information common to the users within the broadcast coverage area, digitally modulating, within the unique information portion, information unique to the users within the broadcast coverage area, and transmitting the modulated common and unique information within the coverage area. The communications system, method and computer program product advantageously allows for delivery of TV program information and user specific data over existing 6 MHz terrestrial broadcast channels.

### CROSS REFERENCE TO RELATED PATENT DOCUMENTS

This document contains subject matter related to that described in U.S. Pat. No. 6,023,612, and U.S. patent application Ser. No. 60/216,769, the entire contents of which is incorporated by reference herein. The present document also claims the benefit of the earlier filing date of U.S. patent application Ser. No. 60/216,769.

### BACKGROUND OF THE INVENTION

1. Field of the Invention

The present invention generally relates to the field of wireless communications and more specifically to a method, system and computer program product for wireless data transmission over conventional television frequency bands. The present invention includes use of various technologies described in the references identified in the appended LIST OF REFERENCES and cross-referenced throughout the specification by numerals in brackets corresponding to the respective references. The entire contents of each reference in the appended LIST OF REFERENCES are incorporated herein by reference.

2. Discussion of the Background

The current state of the art in digital television transmission uses one of several modulation schemes to deliver some type of data to the home over a wireless channel. Typically, and certainly in the United States, the channels are allocated in the UHF or VHF bands. With a new digital TV standard that uses substantial amounts of data compression, broadcasters now have the ability to deliver not just a single video and audio program in the allocated 6 MHz channel, but also include multiple programs within the transmitted stream.[1] This is frequently referred to as “multi-casting”. In addition, broadcasters are allowed to allocate a portion of the total bandwidth to deliver generic data.

The ability for a broadcaster to deliver anything other than a single television program is certainly revolutionary. The technology of the television broadcast industry has developed very slowly. Consider, for example, that the television set one might have bought in the 1950's would still operate today with an over-the-air broadcast signal. In today's world, it is unheard of for a communications technology to survive 50 years. Yet, this is the technological environment for the broadcaster.

It all began, when the United States widely implemented the first analog color TV broadcast system in 1953 based on the NTSC standard (National Television System Committee). Today, the NTSC standard is used not only in the United States, but also in most countries of the Western Hemisphere, as well as Japan and some other countries of Asia. Frame rate (i.e., number of times the entire screen is redrawn in a second) is 29.97/second with 525 lines/frame in the NTSC standard.

FIG. 1 is a frequency diagram illustrating the NTSC standard, which includes, within a 6 MHz channel, a luminance carrier 102, a chroma sub-carrier 104 and an audio carrier 106. As shown in FIG. 1, in the NTSC standard, 3.579545 MHz separates the luminance carrier 102 and the chroma sub-carrier 104.

Later in the 50's and early 60's the analog PAL standard (Phase Alternating Line) was adopted by most European countries, except for France, which adopted the SECAM standard (the French acronym for Sequential Color with Memory). These standards allow for better picture quality than NTSC. Both PAL and SECAM have frame rates of 25/second with 625 lines/frame.

FIG. 2 is a frequency diagram illustrating the PAL standard, which also includes, within a 6 MHz (or 7 MHz) channel, a luminance carrier 202, a chroma sub-carrier 204 and an audio carrier 206. As shown in FIG. 2, in the PAL standard, the chroma sub-carrier 204 is positioned at 4.43+MHz.

FIG. 3 is a system diagram for illustrating a typical television broadcast system using the above-noted methods. Such a system typically includes a program producer 302, which transmits program information to a broadcast network operator 306 via a communications network 304. The broadcast network operator 306 then formats the program information and transmits the formatted information 316 to televisions 322 within a transmission area 320 of a transmitter 318. The televisions 322 may be coupled to a set-top controller 324 via signal line 326. The controller transmits billing and ordering information 314 to the telephone company 308 via the public switched telephone network (PSTN) 312. The telephone company 308 then forwards the billing and ordering information 310 to the broadcast network operator 306 via the PSTN 312. With the above-noted system, custom services, such as Web TV, AOL TV, etc., are possible.

Nevertheless, a need for conversion of television broadcast from analog to digital was recognized in the 1980's. Accordingly, a process was begun to do so, which evolved into a standard making body called the Advanced Television Systems Committee (ATSC). [2] In general, the move from analog to digital transmission schemes is driven by the need for more spectrally efficient systems. Bandwidth has become a commodity in today's world; therefore, bandwidth conservation is important. While the analog transmission of a single television program with related audio using the NTSC system requires the use of 6 MHz of bandwidth, as previously described with respect to FIG. 1, the ATSC standard adopted by the FCC in the United States is approximately four times more efficient. That is, one can transmit approximately four equivalent television programs within the same 6 MHz using the digital system.

FIG. 4 is a frequency diagram illustrating the ATSC standard, which includes, within a 6 MHz channel, a pilot carrier signal 402. The ATSC standard uses a modulation scheme referred to as 8-VSB (Vestigial Sideband). [3] The 8-VSB is a trellis coded 8-level vestigial side-band modulation system that delivers up to 19 Mbps in 6 MHz of bandwidth. The bit stream is used to carry the MPEG-2 protocol for the video and the AC-3 Digital Audio Compression for the audio.

When the FCC adopted the current ATSC standard for digital transmission, they allowed the broadcasters to use the entire 6 MHz channel, despite the improved efficiency. Accordingly, broadcasters began to look at potential new uses for their newfound throughput. Various suggestions have been made during the last several years. One suggestion was multicasting multiple “standard definition” programs within a market to compete with cable and satellite systems.

Currently, industry experts seem to agree that some form of data broadcasting, in addition to the TV programs, will be a reality with the new digital television standards. Standardization work is going on that foresees the need for broadcasters to deliver data both related and unrelated to the television program(s) they broadcast. Within the ATSC, a technical subcommittee (referred to as “T3/S13”) is in the process of proposing a draft standard to the parent committee. Additionally, several consortiums of broadcasters, such as iBlast [4], and GEOCAST [5], have announced their intentions to provide data delivery services.

Another technique for digital transmission is based on a modulation scheme referred to as Coded Orthogonal Frequency Division Multiplexing (COFDM). [3, 6, 7] The basic idea of COFDM comes from the observation of the impairment occurring during the terrestrial channel propagation. The response of the channel is not identical for each of its frequency sub-bands. Due to the sum of received signals (i.e., due to destructive/constructive interference), (i) no energy is received, or (ii) energy up to and equal to the energy transmitted is received. Accordingly, the first mechanism of COFDM is to spread the data over a large number of closely spaced frequency sub-bands. Additionally, to reconstruct the lost data in the receiver, the useful data are encoded before transmission. The “Coded” and “Frequency Division Multiplex” abbreviations come from these two simple concepts. [6, 7]

Unfortunately, the characteristics of the transmission channel are not constant in the time domain. But, during a short time interval, the terrestrial channel propagation characteristics are stable. Accordingly, as shown in FIG. 5, COFDM implements a partitioning of the terrestrial transmission channel, both in the time domain and in the frequency domain, to organize the RF channel as a set of narrow “frequency sub-bands” and as a set of small contiguous “time segments”. Inside each time-segment, named OFDM symbol, each frequency sub-band is equipped with one sub-carrier 502. To avoid inter-carrier interference, these carriers are arranged to be orthogonal, which means the inter-carrier spacing in the frequency domain is set to be equal to the inverse of the symbol duration 504 so that the cross-product of any two carriers is zero. As “echoes” are constituted with delayed replicas of the original signal, the end of a given OFDM symbol produces inter-symbol interference with the beginning of the following one. To avoid this effect, a guard interval 506 is inserted in the time domain between each OFDM symbol, as shown in FIG. 5. [6, 7]

During the guard interval period 506, the receivers ignore the received signal energy since it may be corrupted. To demodulate properly the signal, the receivers have to sample during the useful period of the OFDM symbol (i.e., not during the guard interval). Accordingly, a time window has to be accurately placed in regard to the instant where each OFDM symbol occurs on air. The synchronization strategy used in terrestrial transmissions is to insert synchronization markers, allowing the delineation of the transmission frame by use of “pilot” sub-carriers, regularly spread in the transmission channel, as synchronization markers. [6, 7]

With COFDM there is the possibility of implementing both Multi-Frequency Networks (MFNs) and Single Frequency Networks (SFNs). FIG. 6 illustrates a typical MFN, which includes a multiplexer 602, a primary distribution network 604, a GPS frequency reference 606, a COFDM modulator 608, an up converter 610, a power amplifier 612, and a transmitter 614, which transmits the COFDM signal to receivers 616 within a transmitter coverage area 618. The COFDM modulator 608 includes a bitrate adapter 608a, an empty packet inserter 608b and a COFDM processor 608c. [6]

FIG. 7 illustrates a typical SFN, which includes a multiplexer 702, GPS frequency references 706, 720 and 724, a processor 708, a primary distribution network 704, COFDM processors 722, and 726, up converters 710 and 728, power amplifiers 712 and 730, and transmitters 714 and 732, which transmit the COFDM signal to receivers 716 within transmitter overlapping coverage areas 718 and 734. The processor 708 includes a bitrate adapter 708a, an empty packet inserter 708b. Due to the overlapping coverage areas of the SFN, each transmitter 714 and 732 must radiate (i) on the same frequency, (ii) at the same time, and (iii) with the same data bits. [6, 7]

However, despite the significant activity in the digital arena, the above-noted conventional models consider that the broadcast station will broadcast only a single channel (6 MHz) to their existing coverage area. They typically will use only the portion of the spectrum left over after the television program is delivered. The only attempt to increase the total amount of data delivered to a particular area is by using multiple broadcasters (and therefore different frequencies/channel assignments) in the same market.

### SUMMARY OF THE INVENTION

Accordingly, an object of this invention is to provide a novel method, system and computer program product for delivery of television program and data over an existing 6 MHz channel.

The above and other objects are achieved according to the present invention by providing a novel communications system, method and computer program product that uses transmits in a terrestrial analog broadcast channel digital information common to users within a broadcast coverage area and digital information unique to users within the broadcast coverage area. The system, method and computer program product further include partitioning the terrestrial analog broadcast channel into a common information portion and a unique information portion, digitally modulating, within the common information portion, information common to the users within the broadcast coverage area, digitally modulating, within the unique information portion, information unique to the users within the broadcast coverage area, and transmitting the modulated common and unique information within the coverage area. The communications system, method and computer program product advantageously allow for delivery of TV program information and user specific data over existing 6 MHz terrestrial broadcast channels.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a frequency diagram illustrating the NTSC analog transmission standard;

FIG. 2 is a frequency diagram illustrating the PAL analog transmission standard;

FIG. 3 is a system diagram illustrating a typical NTSC/PAL/SECAM television broadcasting system;

FIG. 4 is a is a frequency diagram illustrating the 8-VSB digital transmission standard;

FIG. 5 is a is a time/frequency diagram illustrating the COFDM digital transmission standard;

FIG. 6 is a system diagram illustrating a typical COFDM multi-frequency network;

FIG. 7 is a system diagram illustrating a typical COFDM single-frequency network;

FIG. 8 is a frequency diagram illustrating the 8-VSB digital transmission standard modified to allow both data and television program transmission, according to the present invention;

FIG. 9 is a system diagram illustrating an exemplary television and data 8-VSB digital broadcasting system, according to the present invention;

FIG. 10 is a system diagram detailing the television and data 8-VSB digital broadcasting system coverage area of FIG. 9, according to the present invention;

FIG. 11a is a block diagram illustrating the modulation architecture of the television and data 8-VSB digital broadcasting system of FIG. 9, according to the present invention;

FIG. 11b is a block diagram illustrating the demodulation architecture of the television and data 8-VSB digital broadcasting system of FIG. 9, according to the present invention;

FIG. 11c is a flow chart illustrating the modulation scheme for the television and data 8-VSB digital broadcasting system of FIG. 9, according to the present invention;

FIG. 11d is a flow chart illustrating the demodulation scheme for the television and data 8-VSB digital broadcasting system of FIG. 9, according to the present invention;

FIGS. 12-14 are time/frequency diagrams illustrating the COFDM digital transmission standard modified to allow both data and television program transmission, according to the present invention;

FIG. 15 is a system diagram detailing the television and data COFDM digital broadcasting system coverage area, according to the present invention;

FIG. 16a is a block diagram illustrating the modulation architecture of the television and data COFDM digital broadcasting system, according to the present invention;

FIG. 16b is a block diagram illustrating the demodulation architecture of the television and data COFDM digital broadcasting system, according to the present invention;

FIG. 16c is a flow chart illustrating the modulation scheme for the television and data COFDM digital broadcasting system, according to the present invention;

FIG. 16d is a flow chart illustrating the demodulation scheme for the television and data COFDM digital broadcasting system, according to the present invention;

FIG. 17 is frequency diagram illustrating an 8-VSB/COFDM digital transmission to allow both data and television program transmission, according to the present invention;

FIG. 18 is a system diagram detailing the television and data 8-VSB/COFDM digital broadcasting system coverage area, according to the present invention;

FIG. 19a is a block diagram illustrating the modulation architecture of the television and data 8-VSB/COFDM digital broadcasting system, according to the present invention;

FIG. 19b is a block diagram illustrating the demodulation architecture of the television and data 8-VSB/COFDM digital broadcasting system, according to the present invention;

FIG. 19c is a flow chart illustrating the modulation scheme for the television and data 8-VSB/COFDM digital broadcasting system, according to the present invention;

FIG. 19d is a flow chart illustrating the demodulation scheme for the television and data 8-VSB/COFDM digital broadcasting system, according to the present invention;

FIG. 20 is a schematic illustration of a general-purpose computer, which can be programmed according to the teachings of the present invention; and

FIG. 21 is a schematic illustration of a general-purpose microprocessor-based system, which can be programmed according to the teachings of the present invention.

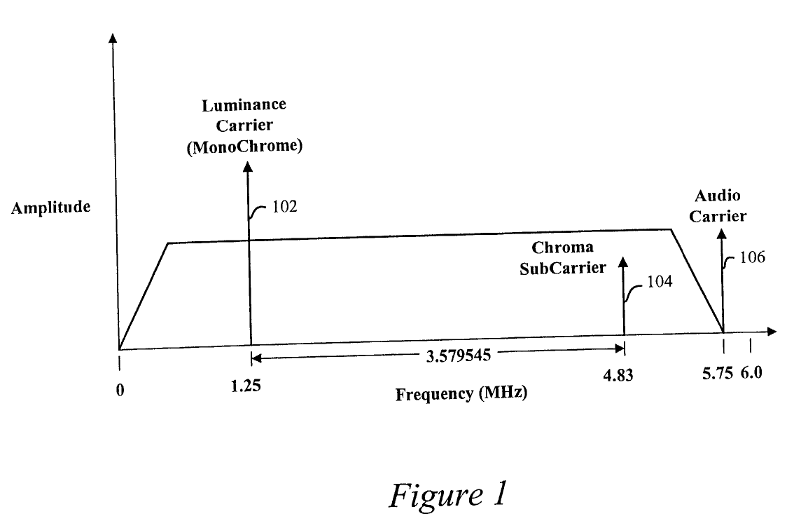

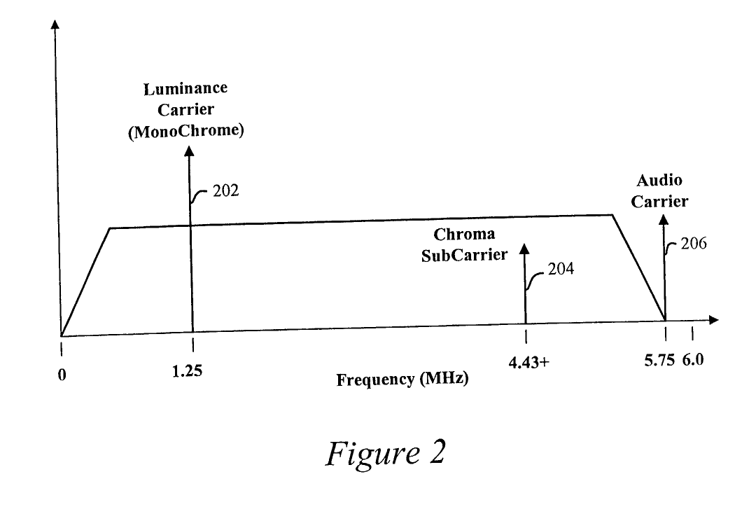

### DESCRIPTION OF THE PREFERRED EMBODIMENTS

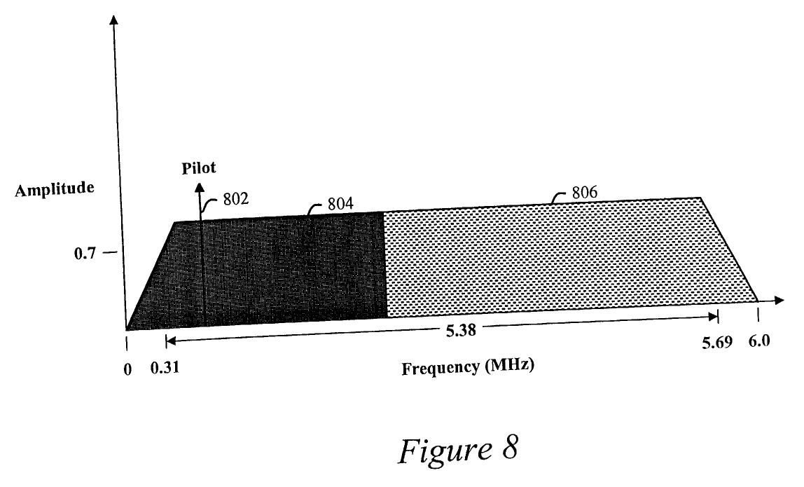

Referring now to the drawings, wherein like reference numerals designate identical or corresponding parts throughout the several views, and more particularly to FIGS. 8-21 thereof, there are shown various embodiments of the present invention, as will now be described.

The ATSC system for terrestrial broadcast allows for a payload data rate of approximately 19.29 Mbits per second (not including the MPEG sync byte). Given today's compression technologies, one can easily accommodate a video and audio program of equal or greater quality than what is broadcast today within between 6 and 8 Mbits per second. For the purpose of discussion, it is assumed this will occupy about 7.29 Mbits/sec of the payload, leaving 12 Mbits/sec of unused bandwidth in the channel. With the flexibility of the standard, this bandwidth could be used to provide data to viewers within range of the transmitter. However, there is no known business model that exploits this in a way that makes economic sense for broadcasters. One reason is that this data must serve everyone in the viewing area, so the capability to send interactive data is severely limited. Given a conservative estimate of 10,000 viewers using the data at any given time, this leaves each user with only 1.2 kilobits per second (a rate much slower than that which today's telephone modems are capable).

The methods described below allow the broadcaster to partition the broadcast audience into geographic locations served by separate transmitters. Each transmitter can then devote the data portion of the bandwidth to serve only the subscribers in that geographic area. By dividing the audience into small groups, the total data bandwidth for each group remains the same, 12 Mbits/sec in our example. The total data delivered by the broadcaster is this data rate multiplied by the number of transmitters deployed.

The present invention presents various methods to allow the broadcaster to transmit a television program to an audience, while partitioning the data portion of the spectrum to reach a small segment of the audience. In each case, the viewing area is divided into “cells” which are serviced by individual transmitters.

One method uses 8-VSB, the existing ATSC modulation standard, modified to transmit both a television program and data and will be described with reference to FIGS. 8-11d. As shown symbolically in FIG. 8, the 6 MHz 8-VSB modulated channel using pilot 802, is divided into a TV program portion 804 (e.g., having a bandwidth of 2 MHz) and a data portion 806 (e.g., having a bandwidth of 4 MHz). Although the diagram of FIG. 8 implies that the TV program portion 804 and the data portion 806 are partitioned by frequency, in a preferred embodiment, the data 806 is randomized with the TV program portion 804 (e.g., via a multiplexer) and distributed across the entire 6 MHZ channel.

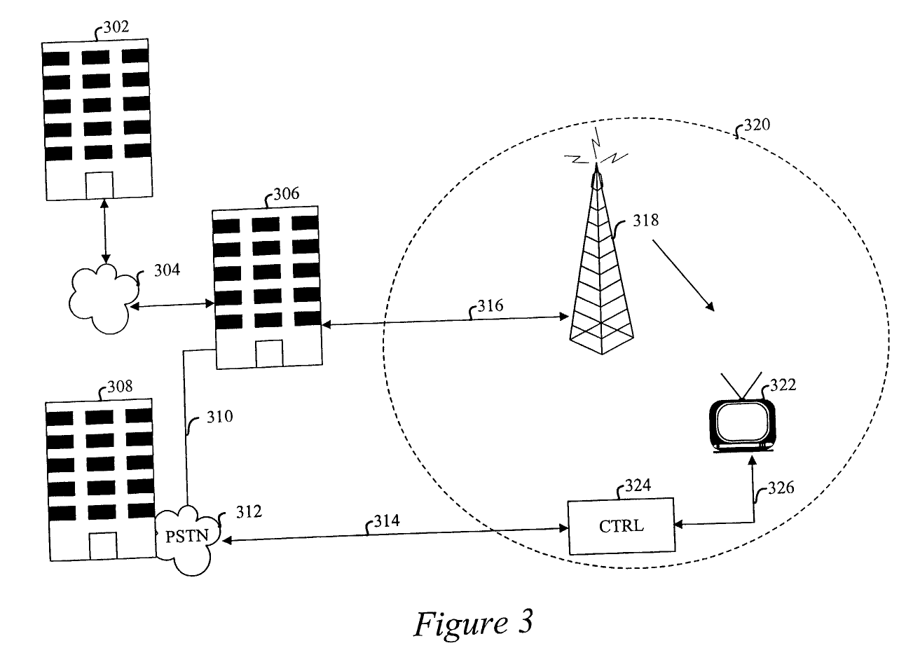

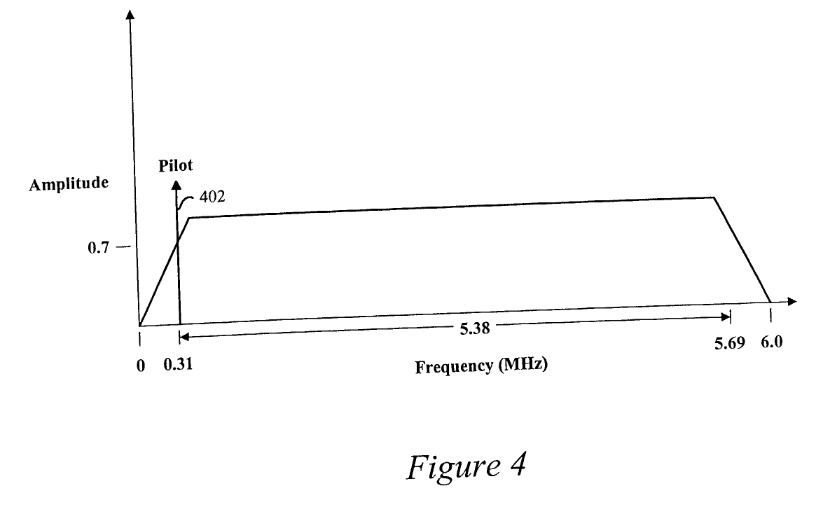

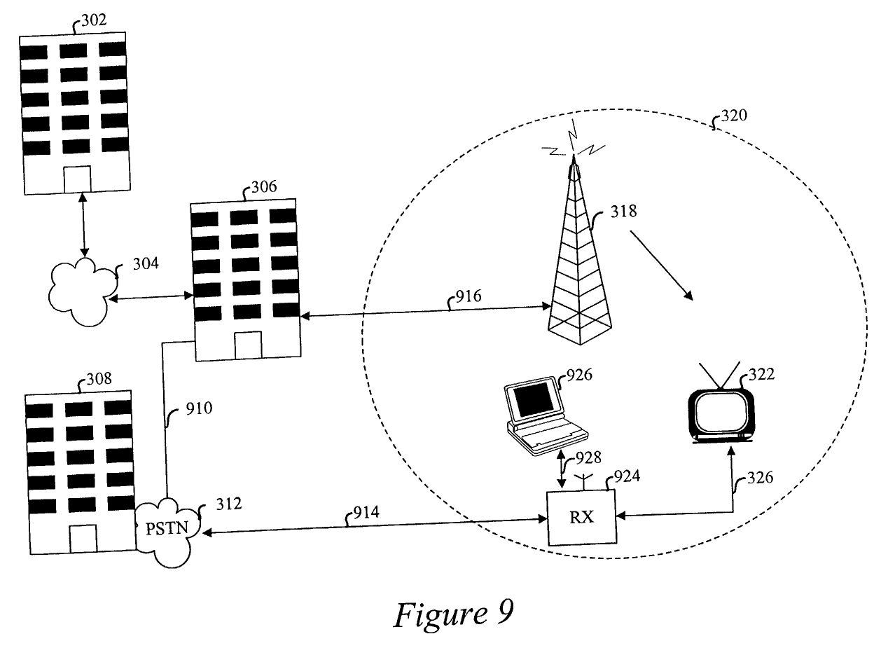

As shown in FIG. 9, the conventional analog system of FIG. 3 is modified to support digital transmission of both a television program and data. In FIG. 9, the program producer 302 transmits television program information to the broadcast network operator 306 via a communications network 304. The broadcast network operator 306 then formats the program information and the data and transmits the formatted information 916 to televisions 322 within the transmission area 320 of the transmitter 318. The televisions 322 are coupled to a set-top receiver 924 via signal line 326. The receiver 924 is also coupled to a data device 926, such as a personal computer, via signal lines 928. The data device 926 thus is able to receive data and make requests for data via the receiver 924. The receiver 924 transmits billing and ordering information and sends data requests as information 914 via, for example, the telephone company 308 and the public switched telephone network (PSTN) 312. The telephone company 308 then forwards the information 914 to the broadcast network operator 306 via the PSTN 312. With the above-noted system, not only are services, such as Web TV, AOL TV, etc., possible, but also custom data services, such as the Internet, e-mail, video-on-demand, audio-on-demand, Internet telephony, virtual private networks (VPNs), etc., are also possible.

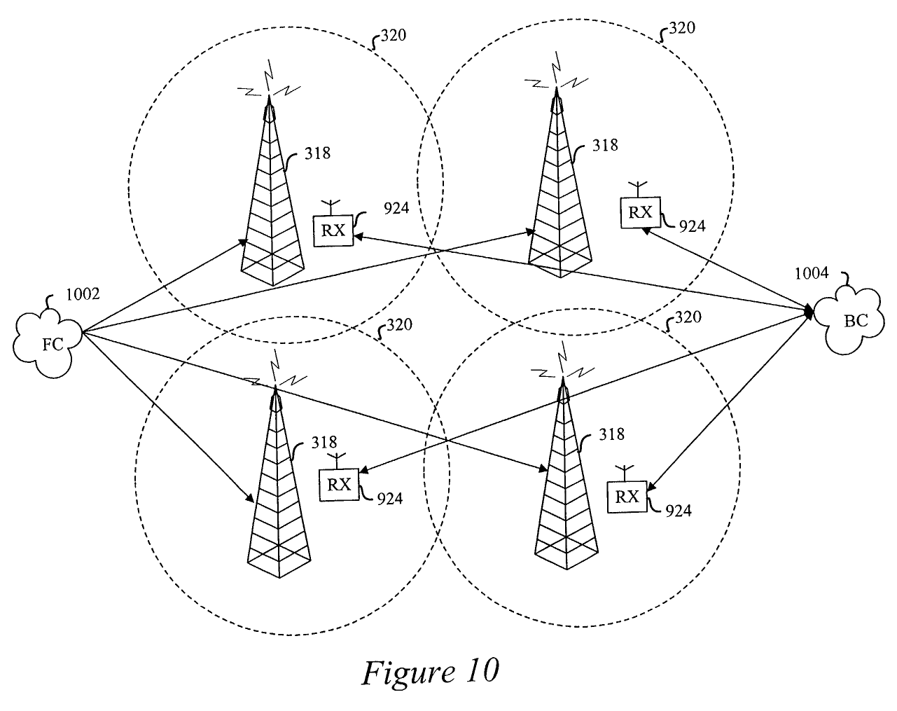

The above-noted method operates by dividing a coverage area of a licensed broadcast station 306 into cells 320, as shown in FIG. 10. Each cell in the coverage area services a certain number of users via front channel 1002, transmitters 318 and receivers 924 and uses back channel 1004 to receive the information 914. The cells 320 and transmitting sites for the transmitters 318 are chosen so that interference regions between cells are minimized. Each cell transmits an ATSC compliant spectrum (i.e., 8-VSB) in the allocated channel. The television program information (video, audio and metadata) is the same for each cell. The data portion of the payload is different for each cell. Each transmitter 320 receives an ATSC compliant transport stream and performs 8-VSB modulation. However, since the data portion is different for each cell 320, the final transmitted signal is not correlated between cells 320. Accordingly, since two different 8-VSB signals broadcast on the same frequency they look like white noise to each other and they will interfere with one another as if the other transmitters 318 in other cells 320 were transmitting noise.

Accordingly, the cell sites 320 typically should be chosen so that, for example, a greater than 15 dB desired-to-undesired ratio (i.e., carrier-to-noise (C/N) ratio) is maintained at every receive location. That is, typically, the total power of noise and signal from all other cell sites 320 operating on the same frequency should be more than 15 dB below the desired signal in order to receive the signal at a predetermined quality. Lower C/N ratios may be used, if lower communications quality is permissible. Reception can be aided by several methods, as will now be discussed.

One method is to use highly directional antennas for the receivers 924 pointed directly at the nearest cell site's transmitter 318. In addition, “smart” antennas, which automatically train themselves on the correct cell site, can be used to optimize reception. Also, diversity antennas can be used so that the receivers 924 can “locate” themselves and choose a correct direction. Finally, an inexpensive GPS system or other geo-location systems (such as a receiver that implements an energy detection scheme coupled to a scanning antenna) can be used to locate the position of the receiver 924 and then instruct an antenna where to point.

Given the noise threshold of the ATSC system, the on-channel signals from the various transmitters 318 typically should not interfere with each other. In order for the above-noted method to function as desired, the coverage area of each transmitter 318 must typically be studied in each city of license. In addition, testing can be conducted to verify the signal propagation to allocate cell cites properly.

Although the above-noted method is described in terms of a coverage area being divided into cells 320, other frequency “re-use” approaches, such as a cellular sectored approach, etc., could be used. If a sectored approach is used, changing the polarization (i.e., horizontal or vertical) of the transmitter 318 antennas from potentially overlapping transmitters can help the receiver 924 antennas distinguish between the desired and undesired signal. Furthermore, sets of directional antennas covering different geographic regions (i.e., sectors”) may be employed.

Another method to improve reception of a desired transmission is to use frequency offsets, by employing an optimum frequency offset scheme that minimizes frequency overlap for multiple 8-VSB transmitters 318 operating on a same channel.

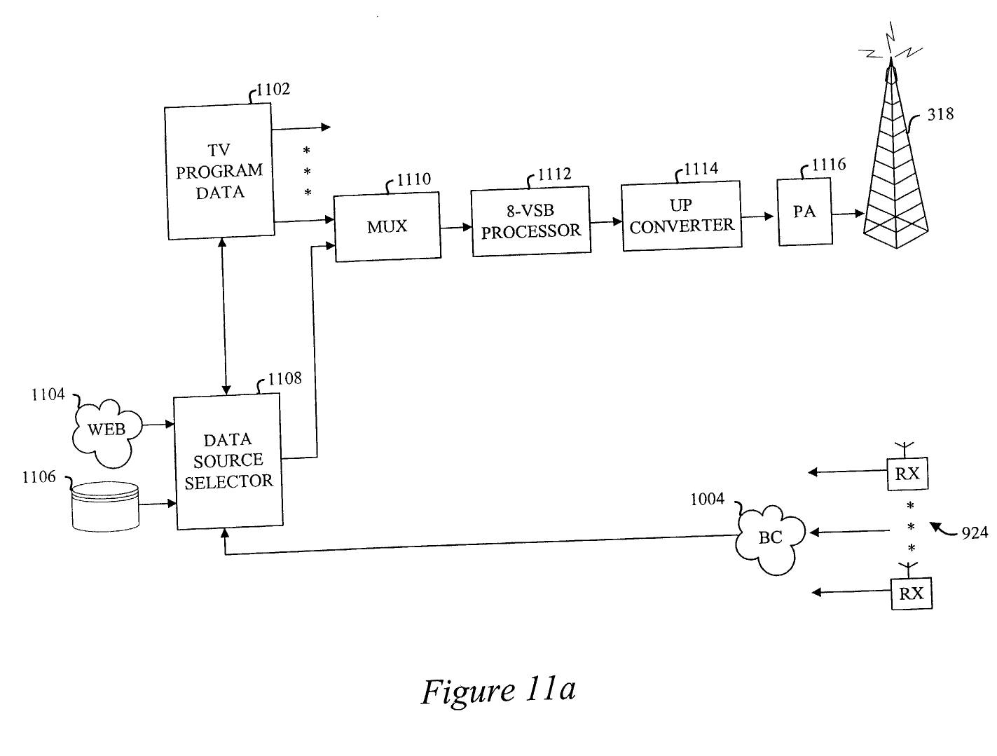

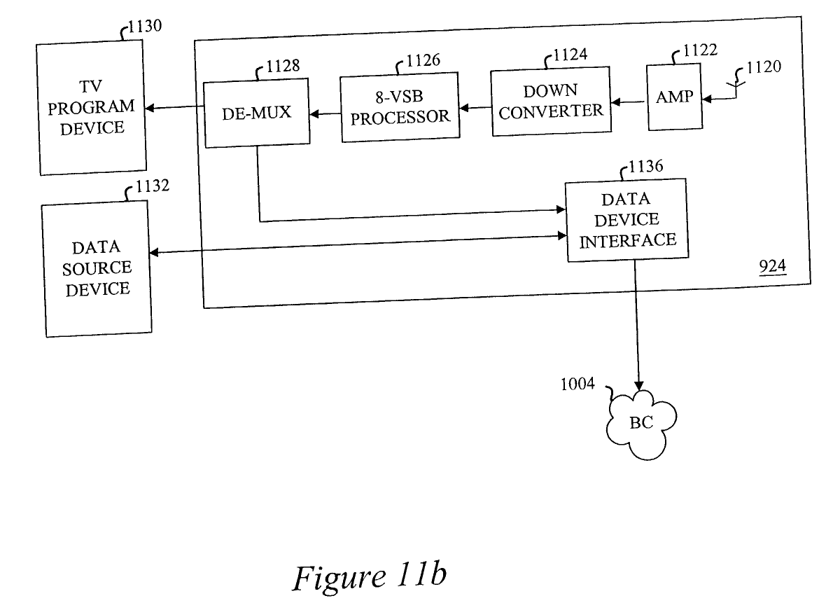

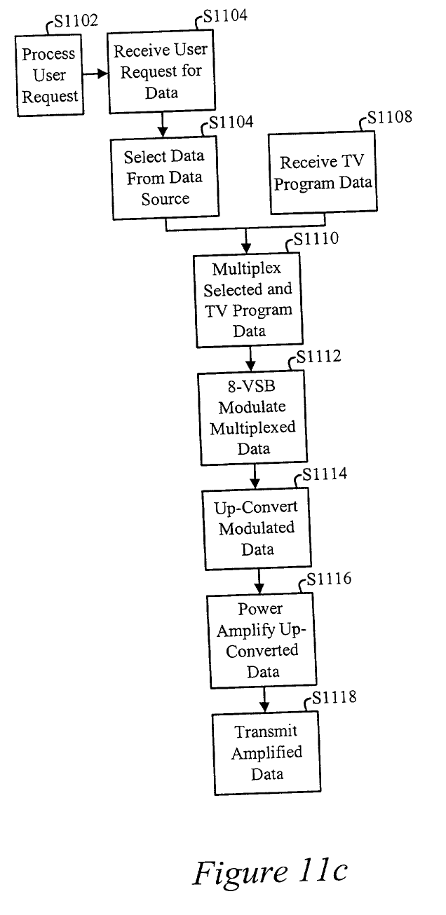

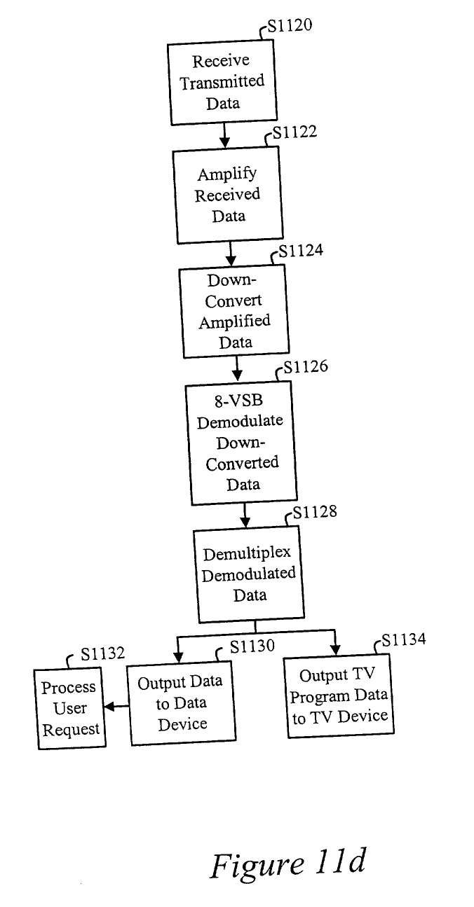

FIG. 11a is a block diagram illustrating the modulation architecture of the television and data 8-VSB digital broadcasting system of FIG. 9. In FIG. 11a, TV program data from TV program data source 1102 and user requested data, such as Internet data 1104 and/or custom data 1106 (e.g., video data, audio data, etc.) from data source selector 1108 is multiplexed by multiplexer 1110. The multiplexed data is then 8-VSB modulated via an 8-VSB processor 1112. The modulated data is then up-converted via up-converter 1114. The up-converted data is then power amplified via power amplifier 1116. The amplified data is then transmitted via transmitters 318 to receivers 924 and TVs 322. The user requests for data are sent via back channel 1004 to the data source selector 1108. The data source selector 1108 is coupled to the TV program data source 1102 to enable television program and data synchronization for providing services, such as Web TV, AOL TV, etc. The back channel 1004 can also be used to transmit user requests for increased data bandwidth to enable bandwidth-on-demand. In this way, the available data bandwidth 806 (FIG. 8) can be dynamically allocated to respective users based on the available and requested bandwidth.

FIG. 11b is a block diagram illustrating the demodulation architecture of the television and data 8-VSB digital broadcasting system of FIG. 9, according to the present invention. The demodulation method is an inverse of the modulation method described with respect to FIG. 11a. In FIG. 11b, the data transmitted by transmitter 318 is received via antenna 1120 and amplified via amplifier 1122. The amplified data is down-converted via down-converter 1124. The down-converted data is then 8-VSB demodulated via 8-VSB processor 1126. The demodulated data is then de-multiplexed via de-multiplexer 1128. The de-multiplexed data is then sent to TV program device 1130 (e.g., a digital television) and a data device interface 1136 (e.g., a TCP/IP-based interface, a wireless-based communications interface, a satellite-based communications interface, a network-based communications interface, etc.). The data source device 1132 (e.g., a personal computer) is coupled to the data device interface 1136 so that data can be received and data requests can be transmitted to the back channel 1004.

FIG. 11c is a flow chart illustrating the modulation scheme for the television and data 8-VSB digital broadcasting system of FIG. 9, according to the present invention. In FIG. 11c, at step S1102, a data request is processed via the back channel 1004. At step S1104, the user request is received and the requested data is selected from the data sources 1104 and 1106 at step S1106. At step S1108, the TV program data 1102 is received and at step S1110, the requested data and TV program data are multiplexed. At step S1112, the multiplexed data is 8-VSB modulated and then up-converted at step S1114. Power-amplifying the up-converted data at step S1116 and transmitting the amplified data at step S1118 complete the process.

FIG. 11d is a flow chart illustrating the demodulation scheme for the television and data 8-VSB digital broadcasting system of FIG. 9, according to the present invention. The demodulation scheme is an inverse of the modulation scheme and includes receiving the modulated data step S1120, amplifying the received data at step S1122, down-converting the amplified data at step S1124, 8-VSB demodulating the down-converted data at step S1126, and de-multiplexing the demodulated data at step S1128. The de-multiplexed data is sent to the data and TV devices at steps S1130 and S1134 and user requests are processed at step S1132, completing the demodulation process.

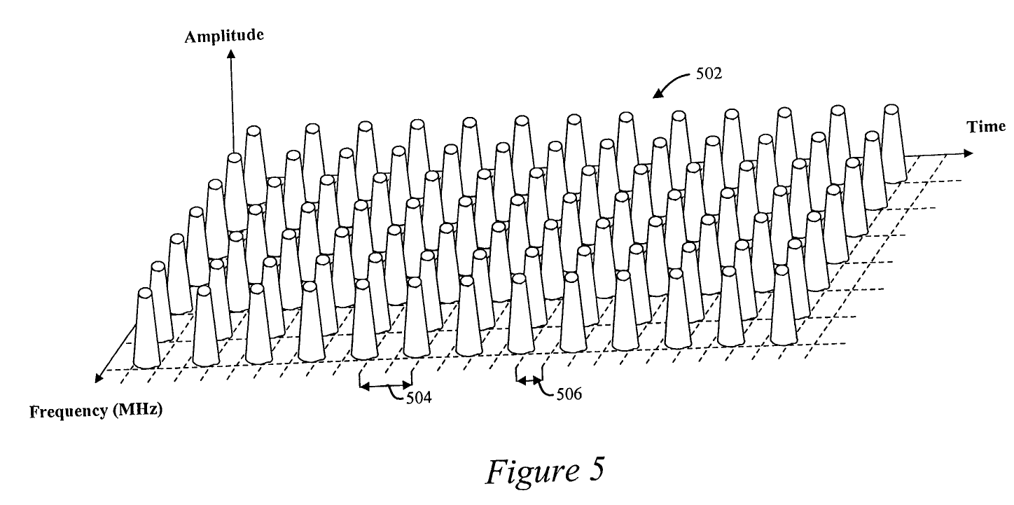

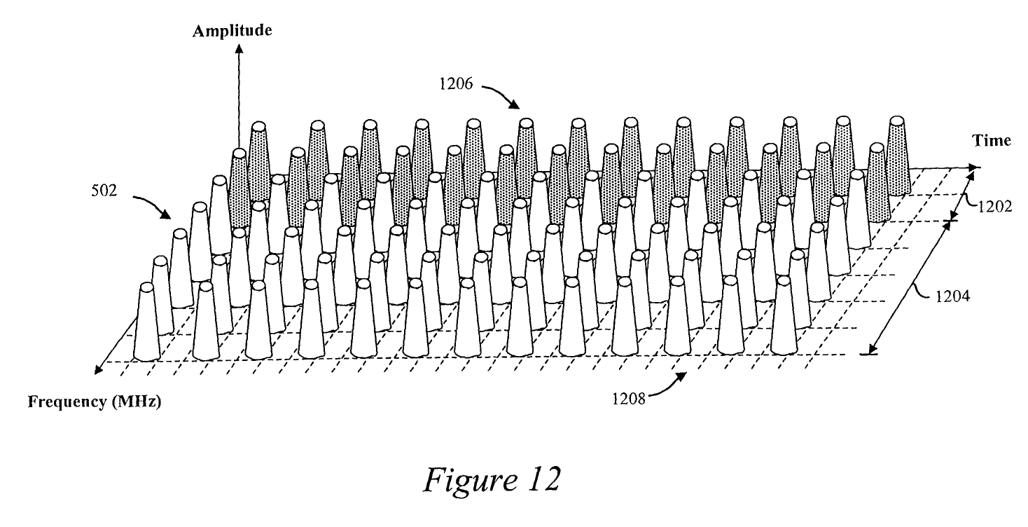

Another method of the present invention to allow the broadcaster to transmit a television program and user specific data will now be described, with reference to FIGS. 12-16d. This method involves the use of the COFDM scheme described with reference to FIG. 5. The second method is a multi-carrier communications system where the transmitted data is split up and modulated onto multiple carriers within the 6 MHz channel. Each carrier can then be digitally modulated with data. At the receive side, the receiver demodulates the data from each carrier and puts the data stream back together.

The broadcast data stream is again divided into the TV program (video, audio and associated metadata) and the user specific data. As shown in FIG. 12, the sub-carriers 502 are divided into two groups. The TV program data is transmitted on sub-carriers 1206 occupying frequency portion 1202 (e.g., 2 MHz) of the 6 MHz channel, while the user specific data is transmitted on sub-carriers 1204 occupying frequency portion 1204 (e.g., 4 MHz) of the 6 MHz channel.

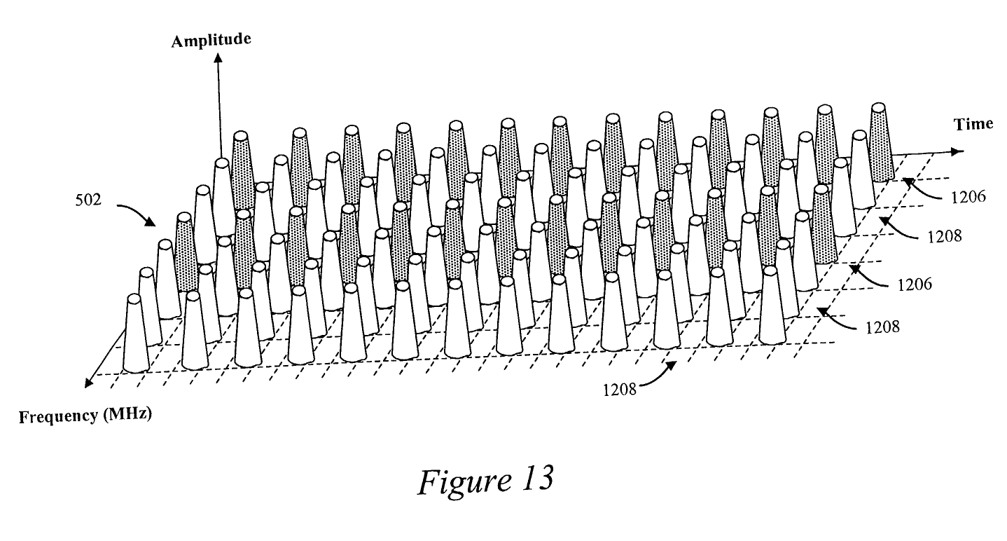

FIG. 13 illustrates a variation of the scheme of FIG. 12, wherein the sub-carriers 1206 and 1208 are located at predetermined frequency positions.

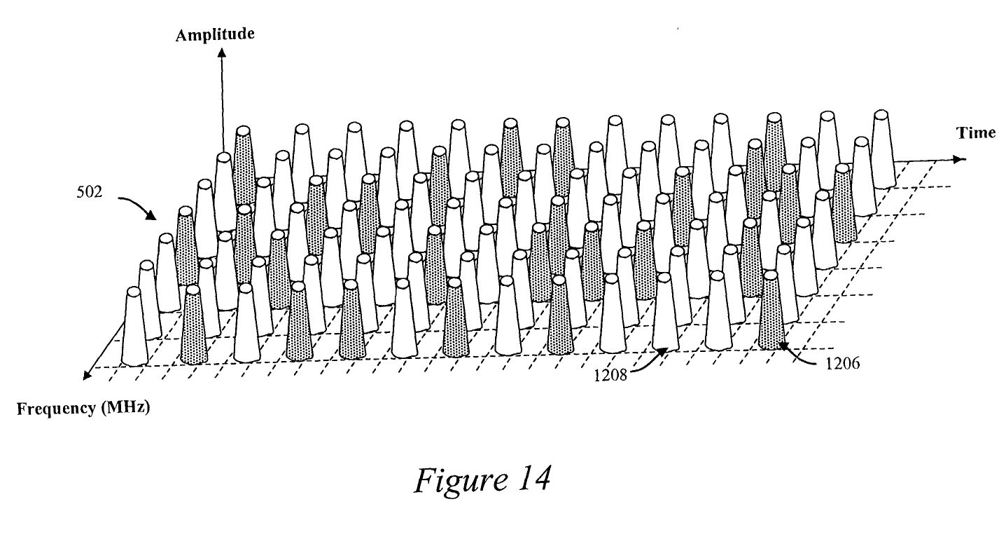

FIG. 14 illustrates a variation of the scheme of FIG. 12, wherein the sub-carriers 1206 and 1208 are located at pseudo-random frequency positions within each transmission time interval.

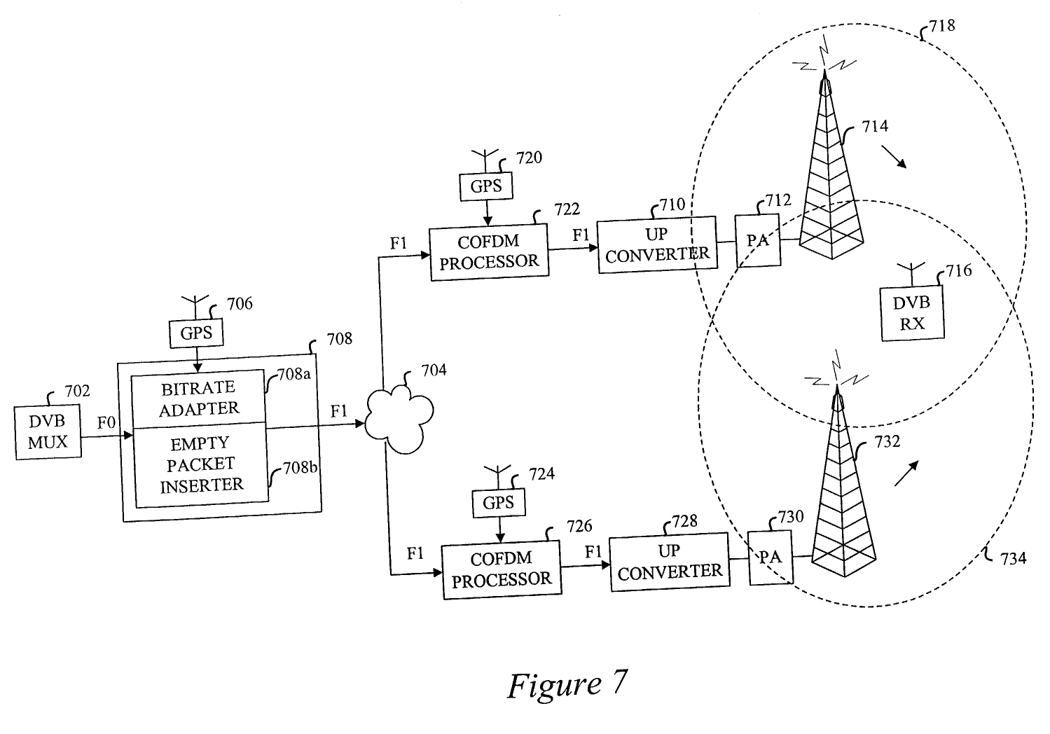

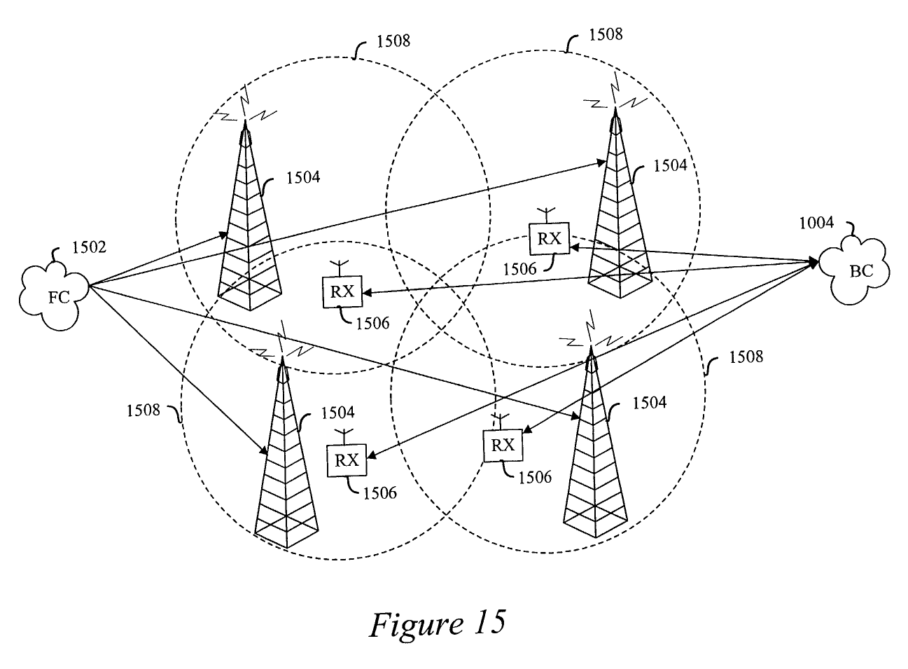

In the above-described method, as shown in FIG. 15, the TV program becomes common to each transmitter 1504 in a cell site 1508 via front channel 1502. Again, multiple transmitters 1504 are used to cover the broadcast area, and the TV program becomes common to each transmitter 1504, while the data is different. This system takes advantage of the fact that COFDM can be used in a Single Frequency Network (SFN) implementation, as described with respect to FIG. 7, allowing overlapping transmitter coverage areas 1508, as shown in FIG. 15. Transmitters 1504 from multiple sites transmitting the same program information are timed so that they do not interfere with each other. Each transmitted signal helps the overall receiver performance. As previously described, the system preserves one portion of the spectrum over a certain number of carriers to contain the TV program itself. The remainder of the spectrum (and carriers) broadcast the data portion. This data portion is different at each transmitter 1504 site for the various locations within the coverage area. Therefore, the TV program benefits from the SFN implementation, but the data does not. Accordingly, care must be taken to ensure that the data portion from one transmitter 1504 does not interfere with the data portion of another transmitter 1504. Several methods can be used to minimize this interference. First and foremost is the careful planning of transmitter 1504 location based on a particular geographic area.

As described with respect to FIGS. 12-14, there are various ways to partition the spectrum into two areas, one for TV and one for data. This can encompass dynamic allocation of bandwidth, “on the fly”, with the ability to have various options available to the broadcaster. Both the transmitter (i.e., modulator) and receiver would function with this division.

In the above-noted method there are two different interference criteria for the two partitions of the spectrum, since the SFN concept for the main program is exploited. Since the TV program is more robust, using carriers modulated with, for example, Quadrature Amplitude Modulation (QAM) is desired for that portion of the spectrum. However, the data portion of the spectrum is subject to interference from the other transmitter 1504 sites. Accordingly, a more robust modulation scheme that will reduce the data rate but improve the reception capability is desired for the data portion of the spectrum. For example, a modulation based on Quadrature Phase Shift Keying (QPSK) or any lower order QAM hierarchy modulation scheme is desired for this portion of the spectrum. Although the above-identified modulation schemes are desirable, other combinations of modulation schemes chosen from, for example, VSB, QAM, QPSK, Binary Phase Shift Keying (BPSK), etc., could be used.

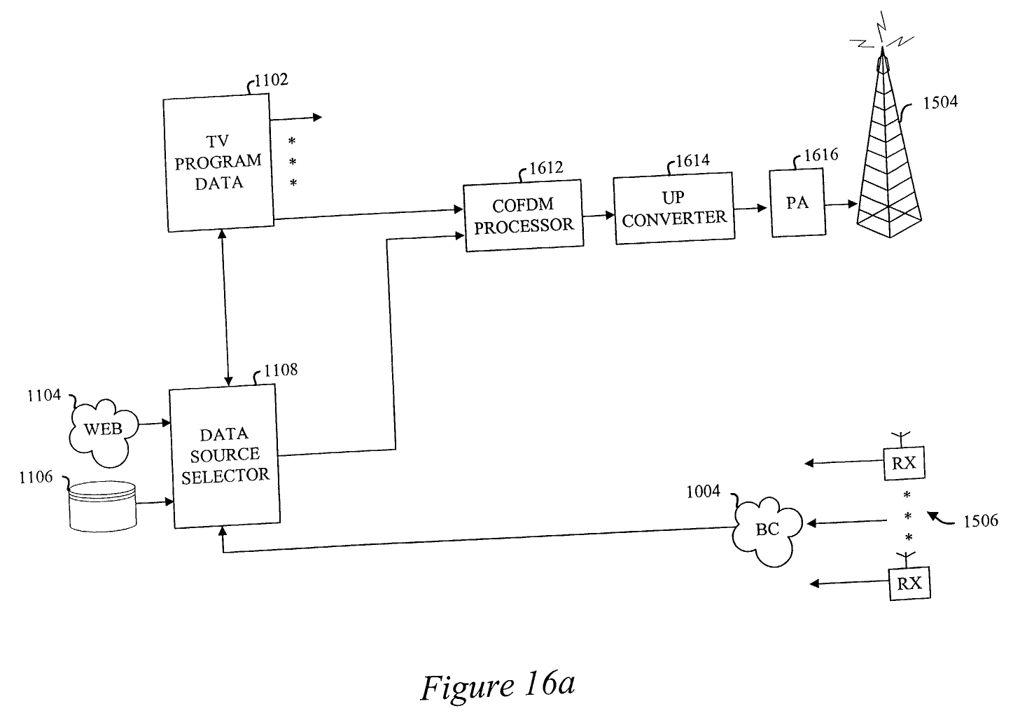

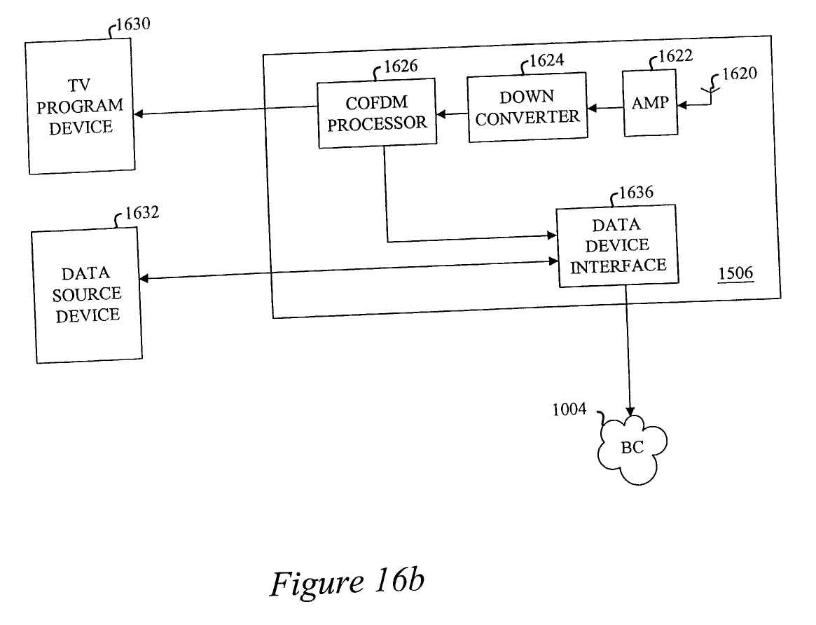

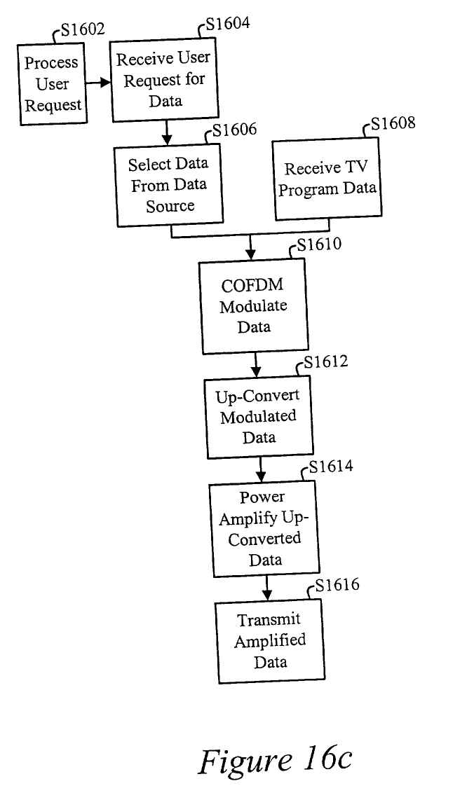

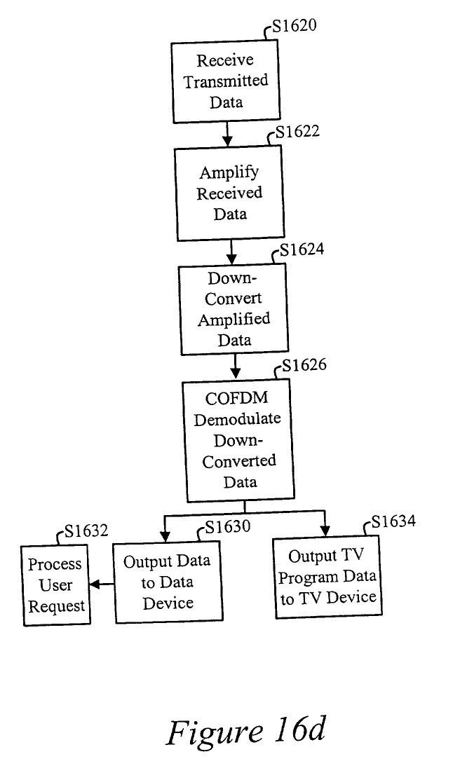

FIG. 16a is a block diagram illustrating the modulation architecture of the television and data COFDM digital broadcasting system, according to the present invention. The devices of FIG. 16a operate in a system similar to that described with respect to FIG. 9, but omitted here for brevity. In FIG. 16a, TV program data from TV program data source 1102 and user requested data, such as Internet data 1104 and/or custom data 1106 (e.g., video data, audio data, etc.) from data source selector 1108 is COFDM modulated via a COFDM processor 1612. The modulated data is then up-converted via up-converter 1614. The up-converted data is then power amplified via power amplifier 1616. The amplified data is then transmitted via transmitters 1504 to receivers 1506 and TVs 322. The user requests for data are sent via back channel 1004 to the data source selector 1108. The data source selector 1108 is coupled to the TV program data source 1102 to enable television program and data synchronization for providing services, such as Web TV, AOL TV, etc. The back channel 1004 can also be used to transmit user requests for increased data bandwidth to enable bandwidth-on-demand. In this way, the available data bandwidth 1204 (FIG. 12) can be dynamically allocated to respective users based on the available and requested bandwidth.

FIG. 16b is a block diagram illustrating the demodulation architecture of the television and data COFDM digital broadcasting system, according to the present invention. The demodulation method is an inverse of the modulation method described with respect to FIG. 16a. In FIG. 16b, the data transmitted by transmitter 1504 is received via antenna 1620 and amplified via amplifier 1622. The amplified data is down-converted via down-converter 1624. The down-converted data is then COFDM demodulated via COFDM processor 1626. The demodulated data is then sent to TV program device 1630 (e.g., a digital television) and a data device interface 1636 (1136 (e.g., a TCP/IP-based interface, a wireless-based communications interface, a satellite-based communications interface, a network-based communications interface, etc.). The data source device 1632 (e.g., a personal computer) is coupled to the data device interface 1636 so that data can be received and data requests can be transmitted to the back channel 1004.

FIG. 16c is a flow chart illustrating the modulation scheme for the television and data COFDM digital broadcasting system, according to the present invention. In FIG. 16c, at step S1602, a data request is processed via the back channel 1004. At step S1604, the user request is received and the requested data is selected from the data sources 1104 and 1106 at step S1606. At step S1608, the TV program data 1102 is received and at step S1610, the requested data and TV program data is COFDM modulated and then up-converted at step S1612. Power-amplifying the up-converted data at step S1614 and transmitting the amplified data at step S1616 complete the process.

FIG. 16d is a flow chart illustrating the demodulation scheme for the television and data COFDM digital broadcasting system, according to the present invention. The demodulation scheme is an inverse of the modulation scheme and includes receiving the modulated data step S1620, amplifying the received data at step S1622, down-converting the amplified data at step S1624, and COFDM demodulating the down-converted data at step S1626. The respective demodulated data is sent to the data and TV devices at steps S1630 and S1634 and user requests are processed at step S1632, completing the demodulation process.

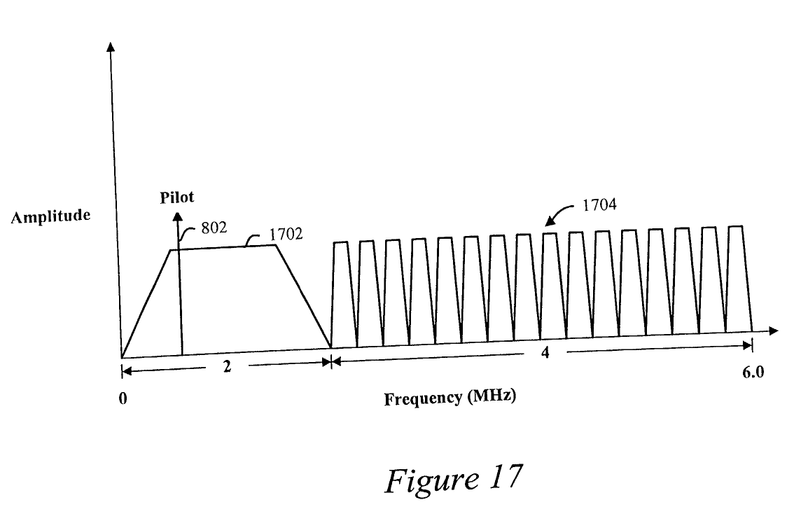

Another method of the present invention to allow the broadcaster to transmit a television program and user specific data will now be described, with reference to FIGS. 17-19d. As shown in FIG. 17, this method is a hybrid of the previous two methods described with respect to FIGS. 8 and 12-14. The present method involves using 8-VSB modulation including pilot 802 within a smaller bandwidth 1702 (e.g., 2 MHz) for TV program data and using the remaining bandwidth 1704 for user specific data modulate with a more robust modulation scheme, such as COFDM QPSK-based modulation.

Good reception of an 8-VSB signal typically involves a very stable and very tightly controlled modulator clock. Accordingly, in order to reduce the bandwidth for TV program data, the modulator clock frequency typically must change, rendering current receivers inoperable without modifying the internal clocking and phase-locked loops (PLLs). This could be a fairly simple procedure and has the advantage of allowing reuse of any existing chip sets that do not have frequency dependent designs.

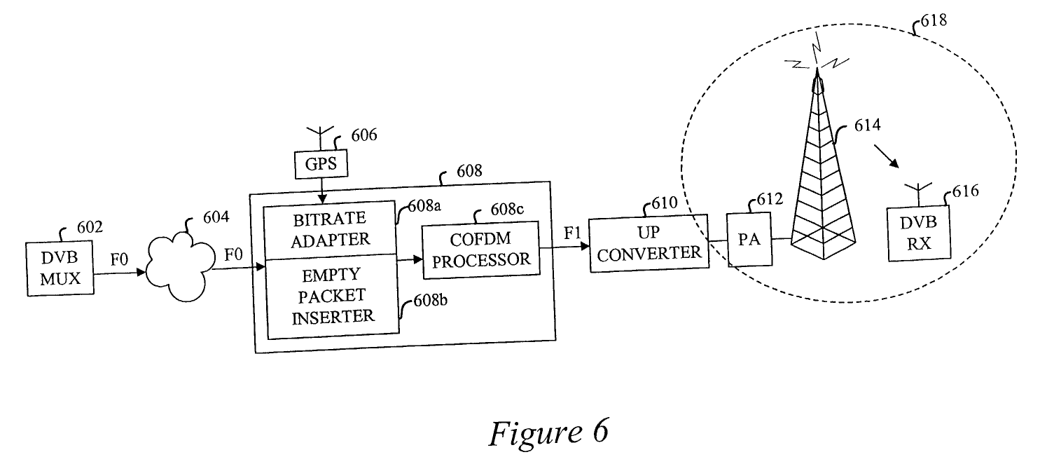

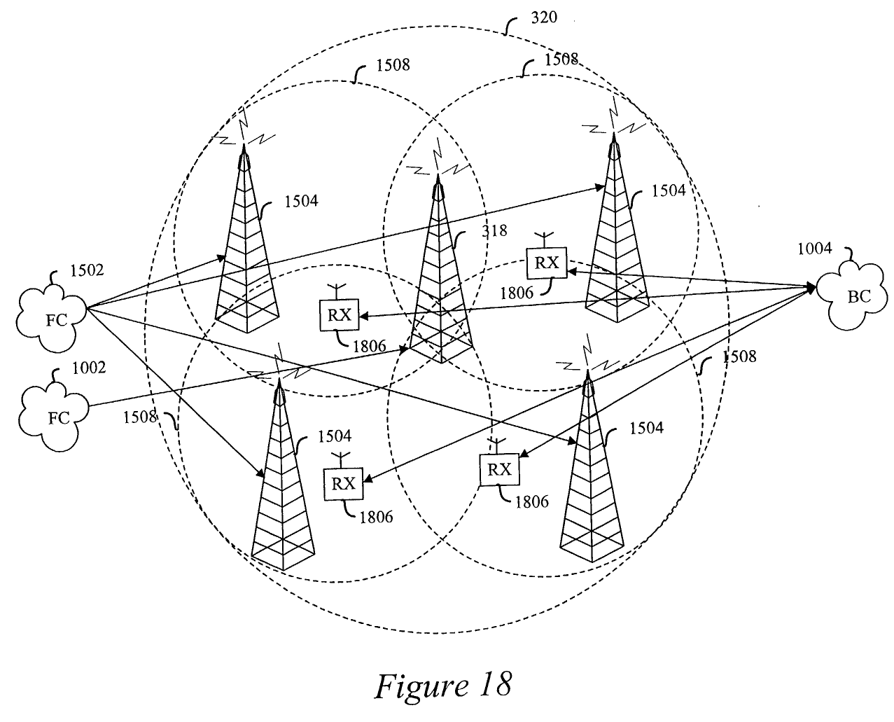

The remaining bandwidth for user specific data should use a modulation scheme that is as robust as possible to interfering signals on the same frequency. Accordingly, QPSK would be an ideal compromise between performance and payload data rate. FIG. 18 is a system diagram detailing the television and data 8-VSB/COFDM digital broadcasting system coverage area based on the above-described method. In FIG. 18, front channel 1002 supplies transmitter 318 with TV program data 8-VSB modulated within coverage area 320, while front channels 1002 supply transmitters 1504 with user specific data COFDM modulated within the respective coverage areas 1508. Back channel 1004 processes user requests received from 8-VSB/COFDM receivers 1806. The COFDM network including the front channel 1502 and the transmitters 1504 can be configured as a MFN, as described with respect to FIG. 6, of low power transmitters.

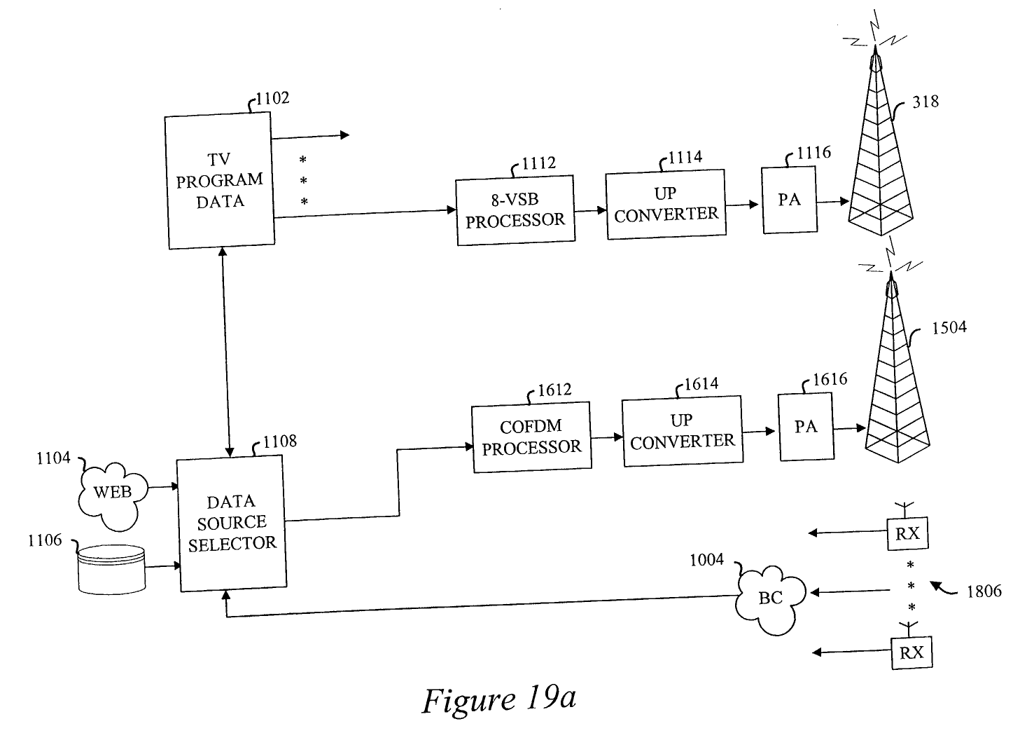

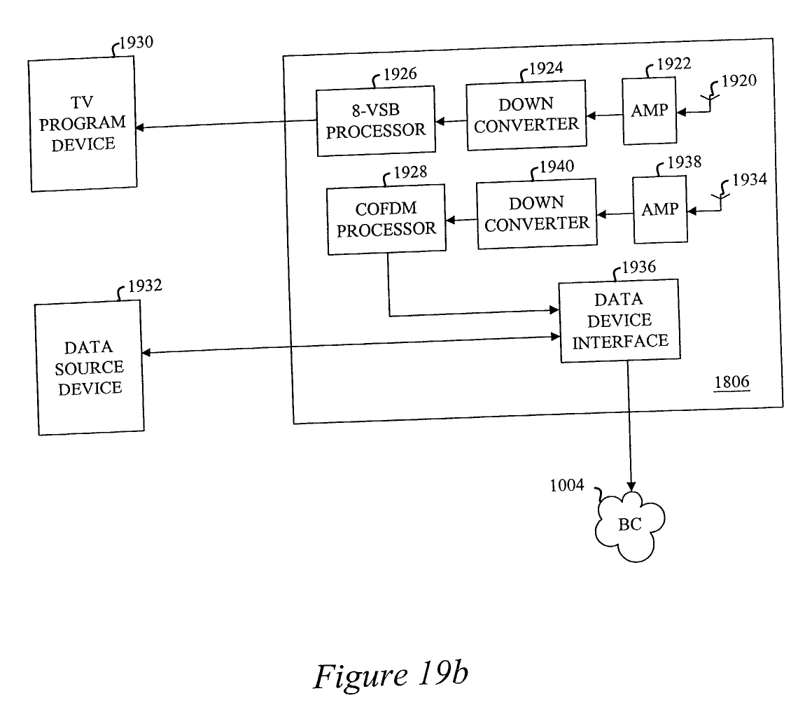

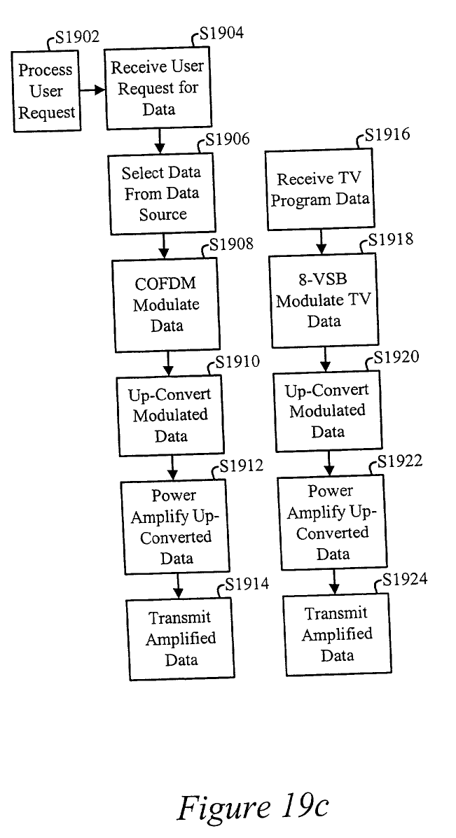

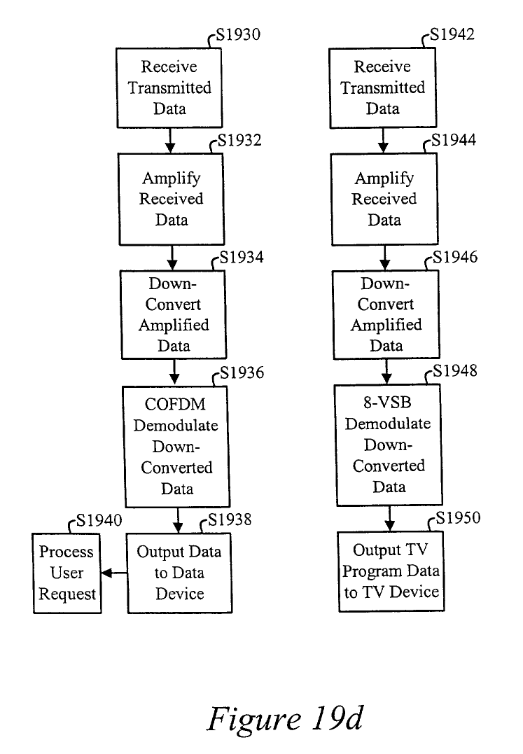

FIG. 19a is a block diagram illustrating the modulation architecture of the television and data 8-VSB/COFDM digital broadcasting system, according to the present invention. The devices of FIG. 19a operate in a system similar to that described with respect to FIG. 9, but omitted here for brevity. In FIG. 19a, TV program data from TV program data source 1102 is 8-VSB modulated via an 8-VSB processor 1112. The modulated data is then up-converted via up-converter 1114. The up-converted data is then power amplified via power amplifier 1116. The amplified data is then transmitted via transmitters 318 to receivers 1806 and TVs 322.

The user requested data, such as Internet data 1104 and/or custom data 1106 (e.g., video data, audio data, etc.) from data source selector 1108 is COFDM modulated via a COFDM processor 1612. The modulated data is then up-converted via up-converter 1614. The up-converted data is then power amplified via power amplifier 1616. The amplified data is then transmitted via transmitters 1504 to receivers 1806 and TVs 322. The user requests for data are sent via back channel 1004 to the data source selector 1108. The data source selector 1108 is coupled to the TV program data source 1102 to enable television program and data synchronization for providing services, such as Web TV, AOL TV, etc. The back channel 1004 can also be used to transmit user requests for increased data bandwidth to enable bandwidth-on-demand. In this way, the available data bandwidth 1204 (FIG. 12) can be dynamically allocated to respective users based on the available and requested bandwidth.

FIG. 19b is a block diagram illustrating the demodulation architecture of the television and data 8-VSB/COFDM digital broadcasting system, according to the present invention. The demodulation method is an inverse of the modulation method described with respect to FIG. 19a. In FIG. 19b, the data transmitted by transmitter 318 and transmitters 1504 is received via antennas 1920 and 1934 and amplified via amplifiers 1922 and 1938, respectively. The respective amplified data is down-converted via down-converters 1924 and 1940. The respective down-converted data is then 8-VSB and COFDM demodulated via 8-VSB processor 1926 and COFDM processor 1928, respectively. The demodulated TV program data is then sent to TV program device 1930 (e.g., a digital television). The demodulated user specific data is sent to data device interface 1936 (e.g., a TCP/IP-based interface). The data source device 1932 (e.g., a personal computer) is coupled to the data device interface 1936 so that data can be received and data requests can be transmitted to the back channel 1004. Although the architecture of FIG. 19b is described in terms of a parallel architecture, duplicated devices (e.g., antennas, down-converters, and processors) can be replaced by single devices, when possible. For example, one antenna, one amplifier, one down-converter and one processor could be used to perform both the 8-VSB and COFDM demodulation.

FIG. 19c is a flow chart illustrating the modulation scheme for the television and data 8-VSB/COFDM digital broadcasting system, according to the present invention. In FIG. 16c, at step S1902, a data request is processed via the back channel 1004. At step S1904, the user request is received and the requested data is selected from the data sources 1104 and 1106 at step S1906. At step S1916, the TV program data 1102 is received. At step S1908 the requested data is COFDM modulated while the TV program data is 8-VSB modulated at step S1918. The respective data is then up-converted at steps S1910 and S1920. Power-amplifying the respective up-converted data at steps S1912 and S1922 and transmitting the respective amplified data at steps S1914 and S1924 complete the process.

FIG. 19d is a flow chart illustrating the demodulation scheme for the television and data 8-VSB/COFDM digital broadcasting system, according to the present invention. The demodulation scheme is an inverse of the modulation scheme and includes receiving the respective modulated data at steps S1930 and 1942, amplifying the respective received data at steps S1932 and S1944, down-converting the respective amplified data at steps S1934 and S1946, and COFDM and 8-VSB demodulating the respective down-converted data at steps S1936 and S1948. The respective demodulated data is sent to the data and TV devices at steps S1938 and S1950 and user requests are processed at step S1940, completing the demodulation process.

One must consider how the data is delivered to each cell site in order for the systems according to the present invention to function properly. Depending on the method used for the forward path, various timing constraints are required. For example, the television program may need to be synchronized, as in the COFDM case. Distribution can be accomplished by using point-to-point microwave links, fiber, coax or even satellite. For the service to work, a back channel 1004 from the user must be established. This can be accomplished by using the PSTN 312 or by the use of any fixed wireless means. Some examples for the back channel include UNII in 5 GHz, the original VHF or UHF analog channel, and the use of the 700 MHz channels that are in public auction, satellite, cable, etc.

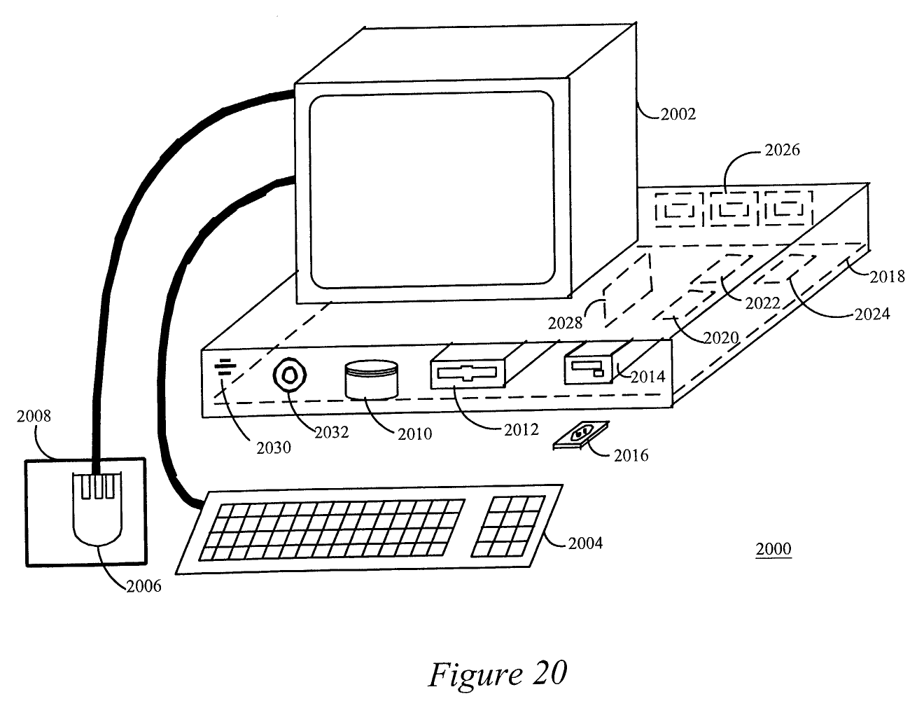

FIG. 20 is a schematic illustration of a general-purpose computer 2000, which can be programmed according to the teachings of the present invention. In FIG. 20, the computer 2000 implements the processes of the present invention, wherein the computer includes, for example, a display device 2002 (e.g., a touch screen monitor with a touch-screen interface, etc.), a keyboard 2004, a pointing device 2006, a mouse pad or digitizing pad 2008, a hard disk 2010, or other fixed, high density media drives, connected using an appropriate device bus (e.g., a SCSI bus, an Enhanced IDE bus, an Ultra DMA bus, a PCI bus, etc.), a floppy drive 2012, a tape or CD ROM drive 2014 with tape or CD media 2016, or other removable media devices, such as magneto-optical media, etc., and a mother board 2018. The mother board 2018 includes, for example, a processor 2020, a RAM 2022, and a ROM 2024 (e.g., DRAM, ROM, EPROM, EEPROM, SRAM, SDRAM, and Flash RAM, etc.), I/O ports 2026, which may be used to couple to external devices, and optional special purpose logic devices (e.g., ASICs, etc.) or configurable logic devices (e.g., GAL and re-programmable FPGA) 2028 for performing specialized hardware/software functions, such as sound processing, image processing, signal processing, neural network processing, automated classification, modulation/demodulation, digital-to-analog/analog-to-digital conversion, etc., a microphone 2030, and a speaker or speakers 2032.

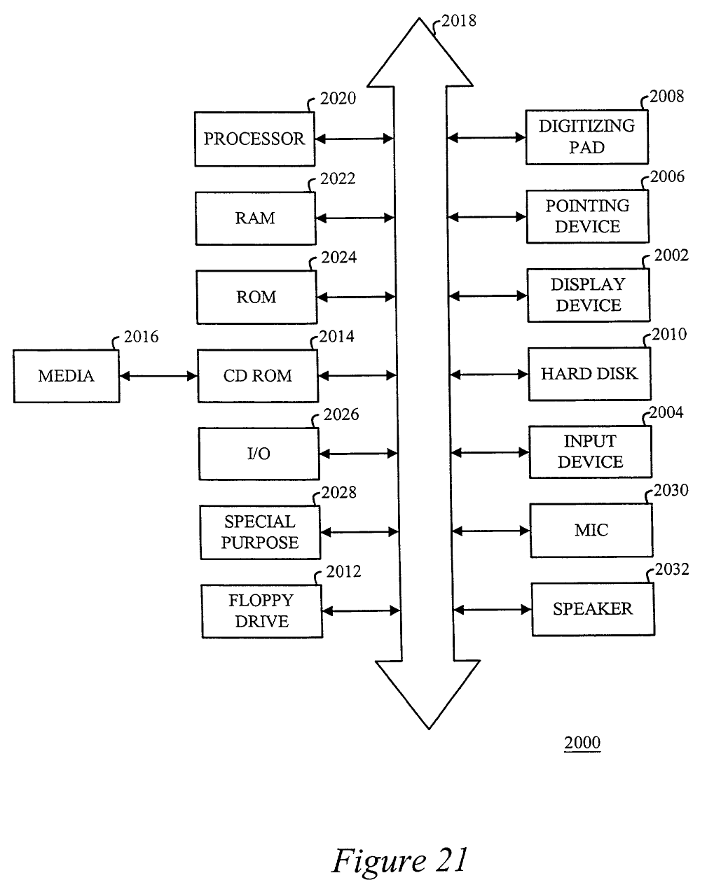

FIG. 21 is a schematic illustration of a general-purpose microprocessor-based or digital signal processor (DSP)-based system 2000, which can be programmed according to the teachings of the present invention. In FIG. 21, the system 2000 implements the processes of the present invention and may include, for example, a display device 2002 (e.g., a liquid crystal display (LCD), etc.), an input device 2004, such as a keyboard, a pointing device 2006, a mouse pad or digitizing pad 2008, a hard disk 2010, or other fixed, high density media drives, connected using an appropriate device bus (e.g., a SCSI bus, an Enhanced IDE bus, an Ultra DMA bus, a PCI bus, etc.), a floppy drive 2012, a tape or CD ROM drive 2014 with tape or CD media 2016, or other removable media devices, such as magneto-optical media, etc., and a mother board or printed circuit board 2018. The board 2018 includes, for example, a processor 2020, such as general-purpose microprocessor or DSP, a RAM 2022, and a ROM 2024 (e.g., DRAM, ROM, EPROM, EEPROM, SRAM, SDRAM, and Flash RAM, etc.), I/O ports 2026, which may be used to couple to external devices, and optional special purpose logic devices (e.g., ASICs, etc.) or configurable logic devices (e.g., GAL and re-programmable FPGA) 2028 for performing specialized hardware/software functions, such as sound processing, image processing, signal processing, neural network processing, automated classification, modulation/demodulation, digital-to-analog/analog-to-digital conversion, etc., a microphone 2030, and a speaker or speakers 2032.

As stated above, the system includes at least one computer readable medium. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 2000 and for enabling the computer 2000 to interact with a human user. Such software may include, but is not limited to, device drivers, operating systems and user applications, such as development tools. Such computer readable media further includes the computer program product of the present invention for performing any of the processes according to the present invention, described above. The computer code devices of the present invention can be any interpreted or executable code mechanism, including but not limited to scripts, interpreters, dynamic link libraries, Java classes, complete executable programs, C and C++ classes, Web authoring, scripting and programming languages, etc.

Accordingly, the mechanisms and processes set forth in the present invention may be implemented using one or more conventional general-purpose microprocessors or computers programmed according to the teachings in the present invention. Appropriate software coding can readily be prepared by programmers of ordinary skill in the computer art(s) based on the teachings of the present invention. However, the present invention also may be implemented by the preparation of application-specific integrated circuits or by interconnecting an appropriate network of conventional component circuits.

The present invention thus also includes a computer-based product which may be hosted on a storage medium and include instructions which can be used to program a general-purpose microprocessor or computer to perform processes in accordance with the present invention. This storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Although the present invention is described in terms of application to wireless terrestrial communication systems, the present invention may be applied to other types of communication systems, such as satellite communication systems, network communication systems, etc., as will be appreciated by those skilled in the relevant art(s).

Although the present invention is described in terms of a coverage area being divided into cells 320 and/or 1508, other frequency allocation approaches, such as a cellular sectored approach, etc., could be used, as will be appreciated by those skilled in the relevant art(s).

Although the present invention is described in terms of providing external receiver devices 924, 1506, and 1806, such receiver devices could be integrated into televisions 322, data devices 926, set-top boxes, set-top terminals, DSL modems, cable modems, telephone modems, etc., as will be appreciated by those skilled in the relevant art(s).

Although the present invention is described in terms of providing external receiver devices 924, 1506, and 1806, such receiver devices could be configured as “television modems,” as will be appreciated by those skilled in the relevant art(s).

Although the present invention is described in terms of providing back channel via the PSTN 312, the back channel could be provided via cable modem, DSL modem, satellite communications, pager networks, cellular networks, microwave communications, etc., as will be appreciated by those skilled in the relevant art(s).

Although the present invention is described in terms of providing back channel using TCP/IP, other protocols could be used, such as Serial Line Internet Protocol (SLIP), Point-to-Point Protocol (PPP), User Datagram Protocol (UDP), Internet Control Message Protocol (ICMP), Interior Gateway Protocol (IGP), Exterior Gateway Protocol (EGP), Border Gateway Protocol (BGP), etc., as will be appreciated by those skilled in the relevant art(s).

Accordingly, in light of the above teachings, numerous modifications and variations of the present invention are possible in the spirit of the present invention. It is therefore to be understood that within the scope of the appended claims, the invention may be practiced otherwise than as specifically described herein.

### LIST OF REFERENCES

[1] ATSC Document A/53 Sep. 16, 1995 ATSC Digital Television Standard with Amendment No. 1 (Mar. 16, 2000), <http://www.atsc.org/Standards/A53/>.

[2] ATV System Recommendation (This report, given to the FCC by the Advisory Committee on Advanced Television Service in February 1993, contains test results and comparisons of the systems that were tested during 1991 and 1992), <http://www.atsc.org/papers/atvreport/index_atvrpt.html>.

[3] Robin Blair, “Digital Techniques in Broadcasting Transmission,” Butterworth-Heinemann, 1999.

[4] <http://www.iblast.com/>.

[5] <http://www.geocast.com/>.

[6] Gerard Faria, “Single Frequency Networks A Magic Feature Of The COFDM”’France Telecom Group, CCETT Publication, <http://www.itis.fr/dab/tec_pap/da_tec01.htm>.

[7] Gerard Faria, “COFDM: An Opportunity To Operate differently Broadcast Networks?,” France Telecom Group, CCETT Publication, <http://www.itis.fr/dab/tec_pap/da_tec01.htm>.

What is claimed as new and desired to be secured by Letters Patent of the United States is:

1. A communications method, comprising:
transmitting in a terrestrial analog broadcast channel digital information common to users within a broadcast coverage area and digital information unique to users within the broadcast coverage area, including,
partitioning the terrestrial analog broadcast channel into a common information portion and a unique information portion,
digitally modulating, within the common information portion, information common to the users within the broadcast coverage area,
digitally modulating, within the unique information portion, information unique to the users within the broadcast coverage area, and
transmitting the modulated common and unique information within the coverage area.

2. The method of claim 1, wherein the step of partitioning comprises partitioning the terrestrial analog broadcast channel in a frequency domain.

3. The method of claim 1, wherein the step of partitioning comprises partitioning the terrestrial analog broadcast channel into a TV program information portion and a user-specific data portion.

4. The method of claim 1, wherein the step of partitioning comprises partitioning a 6 MHZ terrestrial analog broadcast channel into a common information portion and a unique information portion.

5. The method of claim 4, wherein the step of partitioning comprises partitioning the 6 MHZ terrestrial analog broadcast channel into a 2 MHz common information portion and a 4 MHz unique information portion.

6. The method of claim 1, wherein the steps of digitally modulating the common information and digitally modulating the unique information comprise:
multiplexing the common information with the unique information; and
digitally modulating the multiplexed information within the entire terrestrial analog broadcast channel.

7. The method of claim 6, wherein the step of digitally modulating the multiplexed information comprises digitally modulating the multiplexed information using 8-VSB digital modulation.

8. The method of claim 6, wherein the step of transmitting comprises:
up-converting the digitally modulated multiplexed information;
power-amplifying the up-converted information; and
transmitting the power-amplified information within the coverage area.

9. The method of claim 1, wherein the steps of digitally modulating the common information and digitally modulating the unique information comprise:
digitally modulating the common information and the unique information using COFDM digital modulation.

10. The method of claim 9, wherein the step of digitally modulating the common information and the unique information using COFDM digital modulation comprises:
using QPSK-based COFDM digital modulation for the unique information; and
using QAM-based COFDM digital modulation for the common information.

11. The method of claim 9, wherein the step of transmitting comprises:
up-converting the COFDM digitally modulated information;
power-amplifying the up-converted information; and
transmitting the power-amplified information within the coverage area.

12. The method of 11, wherein the step of transmitting the power-amplified information within the coverage area comprises transmitting the power-amplified information within the coverage area of a COFDM single frequency network.

13. The method of claim 1, wherein the step of digitally modulating the common information and digitally modulating the unique information comprise:
digitally modulating the common information using 8-VSB digital modulation; and
digitally modulating the unique information using COFDM digital modulation.

14. The method of claim 13, wherein the step of digitally modulating the unique information using COFDM digital modulation comprises using QPSK-based COFDM digital modulation for the unique information.

15. The method of claim 13, wherein the step of transmitting comprises:
up-converting the 8-VSB digitally modulated information;
power-amplifying the up-converted 8-VSB modulated information;
transmitting the power-amplified 8-VSB modulated information within the entire coverage area;
up-converting the COFDM digitally modulated information;
power-amplifying the up-converted COFDM modulated information; and
transmitting the power-amplified COFDM modulated information to a plurality of portions of the coverage area.

16. The method of 15, wherein the step of transmitting the power-amplified COFDM modulated information comprises transmitting the power-amplified COFDM modulated information to a plurality of portions of the coverage area comprising a COFDM multi-frequency network.

17. A communications system, comprising:
a transmitter configured to transmit in a terrestrial analog broadcast channel digital information common to users within a broadcast coverage area and digital information unique to users within the broadcast coverage area, including,
a partitioning mechanism configured to partition the terrestrial analog broadcast channel into a common information portion and a unique information portion, and
a digital modulator configured to
modulate, within the common information portion, information common to the users within the broadcast coverage area, and
modulate, within the unique information portion, information unique to
the users within the broadcast coverage area, wherein
wherein said transmitter is configured to transmit the modulated common and unique information within the coverage area.

18. The system of claim 17, wherein:
the partitioning mechanism is configured to partition the terrestrial analog broadcast channel in a frequency domain.

19. The system of claim 17, wherein:
the partitioning mechanism is configured to partition the terrestrial analog broadcast channel into a TV program information portion and a user-specific data portion.

20. The system of claim 17, wherein:
the partitioning mechanism is configured to partition a 6 MHZ terrestrial analog broadcast channel into a common information portion and a unique information portion.

21. The system of claim 20, wherein:
the partitioning mechanism is configured to partition the 6 MHZ terrestrial analog broadcast channel into a 2 MHz common information portion and a 4 MHz unique information portion.

22. The system of claim 17, wherein:
the digital modulator includes,
a multiplexer configured to multiplex the common information with the unique information, digitally modulate the multiplexed information within the entire terrestrial analog broadcast channel.

23. The system of claim 22, wherein:
the digital modulator is configured to digitally modulate the multiplexed information using 8-VSB digital modulation.

24. The system of claim 22, wherein the transmitter comprises
an up-converter configured to up-convert the digitally modulated multiplexed information; and
an amplifier configured to power-amplify the up-converted information; and
antenna coupled to the amplifier and configured to radiate the power-amplified information within the coverage area.

25. The system of claim 17, wherein:
the digital modulator is configured to digitally modulate the common information and the unique information using COFDM digital modulation.

26. The system of claim 25, wherein:
the digital modulator uses QPSK-based COFDM digital modulation for the unique information, and QAM-based COFDM digital modulation for the common information.

27. The system of claim 25, wherein the transmitter comprises:
an up-converter configured to up-convert the COFDM digitally modulated information;
an amplifier configured to power-amplify the up-converted information; and
an antenna configured to transmit the power-amplified information within the coverage area.

28. The system of 27, wherein the antenna transmits the power-amplified information within the coverage area of a COFDM single frequency network.

29. The system of claim 17, wherein the digital modulator modulates the common information using 8-VSB digital modulation and the unique information using COFDM digital modulation.

30. The system of claim 29, wherein the digital modulator uses QPSK-based COFDM digital modulation for the unique information.

31. The system of claim 29, wherein the transmitter comprises:
an up-converter configured to up-convert the 8-VSB digitally modulated information and the COFDM digitally modulated information;
an amplifier configured to power-amplify the up-converted 8-VSB modulated information and the up-converted COFDM modulated information; and
an antenna configured to transmit the power-amplified 8-VSB modulated information within the entire coverage area and the power-amplified COFDM modulated information to a plurality of portions of the coverage area.

32. The system of 31, wherein the antenna is configured to transmit the power-amplified COFDM modulated information to a plurality of portions of the coverage area comprising a COFDM multi-frequency network.

33. The system of 17, wherein the partitioning mechanism is implemented as a computer program product.

34. A communications system, comprising:
means for transmitting in a terrestrial analog broadcast channel digital information common to users within a broadcast coverage area and digital information unique to users within the broadcast coverage area, including,
means for partitioning the terrestrial analog broadcast channel into a common information portion and a unique information portion,
means for digitally modulating, within the common information portion, information common to the users within the broadcast coverage area,
means for digitally modulating, within the unique information portion, information unique to the users within the broadcast coverage area, and
means for transmitting the modulated common and unique information within the coverage area.
